(19) United States
(12) Patent Application Publication
(10) Pub. No.: US 2026/0362004 A1
(43) Pub. Date: Nov. 12, 2026

(54) DRIVING DEVICE AND CAMERA ASSEMBLY

(71) Applicant: Luxshare Intelligent Manufacture Technology (Changshu) Co., Ltd, Changshu City (CN)

(72) Inventors: Wenyen HUANG, Changshu City (CN); Chenyu YU, Changshu City (CN); Chiatan HUANG, Changshu City (CN); Qiqing RUAN, Changshu City (CN); Shiping LIN, Changshu City (CN)

(73) Assignee: Luxshare Intelligent Manufacture Technology (Changshu) Co., Ltd, Changshu City (CN)

(21) Appl. No.: 19/402,786

(22) Filed: Nov. 26, 2025

(30) Foreign Application Priority Data
May 9, 2025 (CN) 202510600548.8

(51) Int. Cl. H04N 23/68; H04N 23/51; H04N 23/54; H04N 23/55

(52) U.S. Cl. CPC H04N 23/68; H04N 23/51; H04N 23/54; H04N 23/55

(57) ABSTRACT

Provided are a driving device and a camera assembly. The driving device includes a base, a housing connected to the base, a carrier disposed in an accommodating space formed between the housing and the base, a driving element connected between the carrier and the base, a cover disposed on the carrier, and a shock absorption member connected to the cover. The driving element is configured to drive the carrier to move in a first direction relative to the base. The cover is provided with an open structure configured to avoid the driving element. The shock absorption member includes a first shock absorption portion and a second shock absorption portion, the first shock absorption portion protrudes from the top of the cover, and the second shock absorption portion protrudes from a side of the cover. A camera assembly includes a lens assembly and the driving device.

### CROSS-REFERENCE TO RELATED APPLICATIONS

This application claims priority to Chinese Patent Application No. 202510600548.8 filed May 9, 2025, the disclosure of which is incorporated herein by reference in its entirety.

### TECHNICAL FIELD

The present disclosure relates to the technical field of camera apparatuses and, in particular, to a driving device and a camera assembly.

### BACKGROUND

In a camera assembly, an optical lens is typically fixed on a carrier of a driving device. After the driving device is powered on, a driving element (such as a voice coil motor) drives the carrier and the lens to move linearly along the optical axis direction of the lens, thereby implementing automatic focusing and zooming functions.

### SUMMARY

The present disclosure adopts the technical solutions described below.

A driving device includes a base, a housing connected to the base, a carrier disposed in an accommodating space formed between the housing and the base, a driving element connected between the carrier and the base, a cover disposed on the carrier, and a shock absorption member connected to the cover.

The driving element is configured to drive the carrier to move in a first direction relative to the base.

The cover is provided with an open structure configured to avoid the driving element.

The shock absorption member includes a first shock absorption portion and a second shock absorption portion, the first shock absorption portion protrudes from the top of the cover, and the second shock absorption portion protrudes from a side of the cover.

A camera assembly includes a lens assembly and the driving device in any one of the preceding solutions, the lens assembly is mounted in the carrier of the driving device, the driving device is configured to drive the lens assembly to move along the first direction, and the first direction is the optical axis direction of the lens assembly.

### BRIEF DESCRIPTION OF DRAWINGS

FIG. 1 is a structural view of a driving device according to an embodiment of the present disclosure.

FIG. 2 is a structural view of a driving device with a housing removed according to an embodiment of the present disclosure.

FIG. 3 is an exploded view of a driving device according to an embodiment of the present disclosure.

FIG. 4 is an exploded view of a carrier and a magnet assembly according to an embodiment of the present disclosure.

FIG. 5 is an exploded view of a base and a coil assembly from a first angle according to an embodiment of the present disclosure.

FIG. 6 is an exploded view of a base and a coil assembly from a second angle according to an embodiment of the present disclosure.

FIG. 7 is an exploded view showing a carrier, a cover, and shock absorption members according to an embodiment of the present disclosure.

FIG. 8 is a structural view of the bottom of a carrier according to an embodiment of the present disclosure.

FIG. 9 is a structural view of a shock absorption member according to an embodiment of the present disclosure.

### DETAILED DESCRIPTION

The present disclosure is further described in detail hereinafter in conjunction with the drawings and embodiments. It is to be understood that the embodiments described herein are intended to explain the present disclosure and not to limit the present disclosure. Additionally, it is to be noted that for ease of description, part, not all, of the structures related to the present disclosure are illustrated in the drawings.

In the description of the present disclosure, the terms "joined", "connected", and "fixed" are to be understood in a broad sense unless otherwise expressly specified and limited. For example, the term "connected" may refer to "fixedly connected", "detachably connected", or "integrated", may refer to "mechanically connected" or "electrically connected", may refer to "connected directly" or "connected indirectly through an intermediary", or may refer to "connected inside two elements" or "an interaction relation between two elements". For those of ordinary skill in the art, specific meanings of the preceding terms in the present disclosure may be understood based on specific situations.

In the present disclosure, unless otherwise expressly specified and limited, when a first feature is described as "above" or "below" a second feature, the first feature and the second feature may be in direct contact, or be in contact via another feature between the two features. Moreover, when the first feature is described as "on", "above", or "over" the second feature, the first feature is right on, above, or over the second feature, the first feature is obliquely on, above, or over the second feature, or the first feature is simply at a higher level than the second feature. When the first feature is described as "under", "below", or "underneath" the second feature, the first feature is right under, below, or underneath the second feature, the first feature is obliquely under, below, or underneath the second feature, or the first feature is simply at a lower level than the second feature.

In the description of the present disclosure, it is to be noted that orientations or positional relations indicated by terms such as "above", "below", "left", and "right" are based on the drawings. These orientations or positional relations are intended only to facilitate the description and simplify an operation and not to indicate or imply that a device or element referred to must have such specific orientations or must be configured or operated in such specific orientations. Thus, these orientations or positional relations are not to be construed as limiting the present disclosure. Additionally, the terms "first" and "second" are used for distinguishing between descriptions and have no special meaning.

In the related art, a limit structure is typically disposed on the carrier to reduce the influence of external impact on the driving device. The limit structure is located between the carrier and the housing of the driving device. When the housing is subjected to external impact (for example, a fall-off), the limit structure can reduce the impact of the housing on the carrier. However, noise generated by the movement and impact of the carrier in the operating process of the driving device cannot be reduced through the existing solution. That is, the existing limit structure has poor shock absorption and noise reduction capabilities, and as a result, the driving device still has relatively large noise when operating.

This embodiment provides a driving device. The driving device can be applied to a camera assembly or other apparatuses to solve the problem in the related art that the driving device has poor shock absorption and noise reduction capabilities due to impact and noise generated by the movement of a carrier.

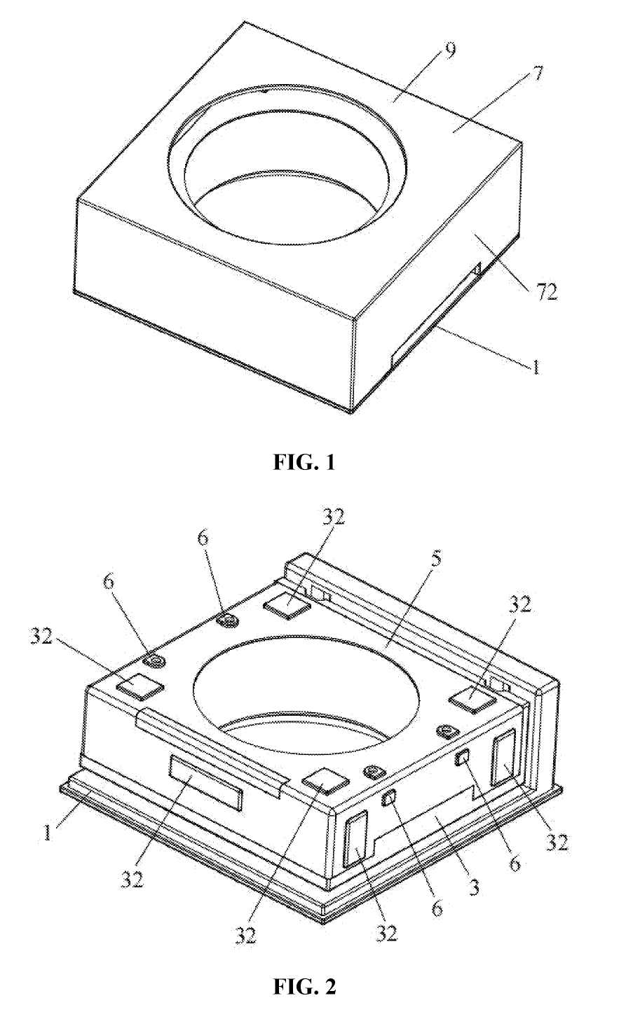

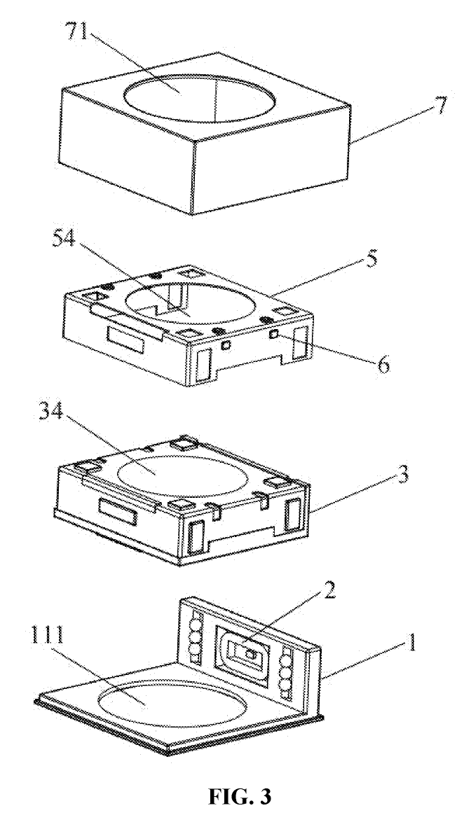

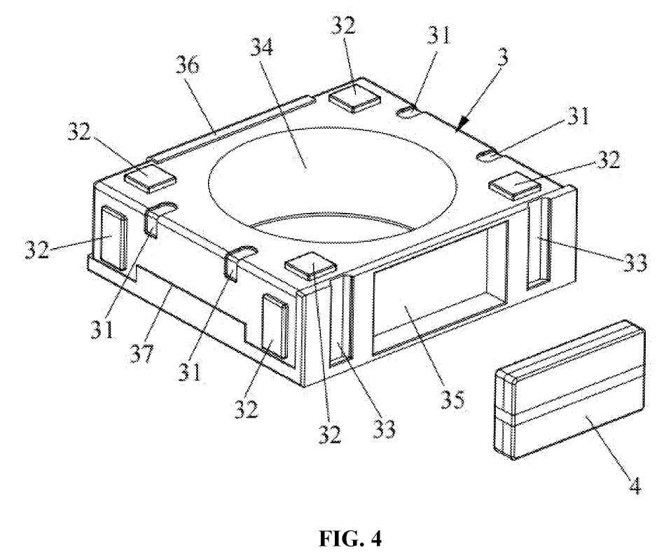

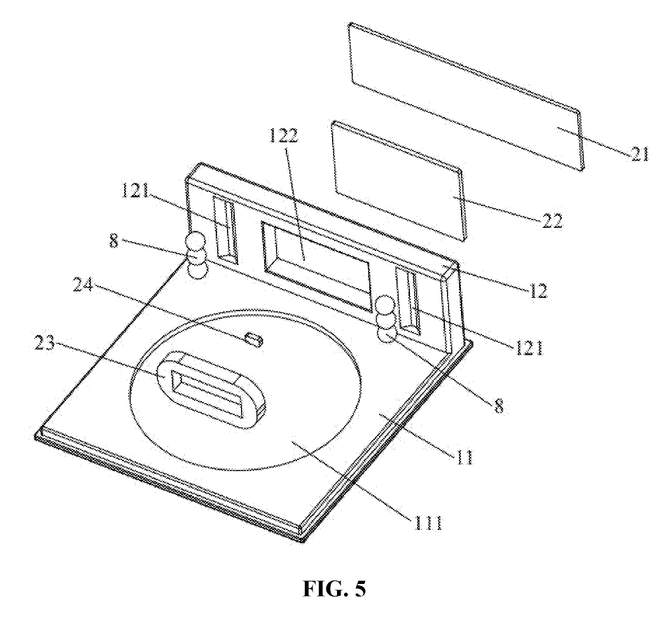

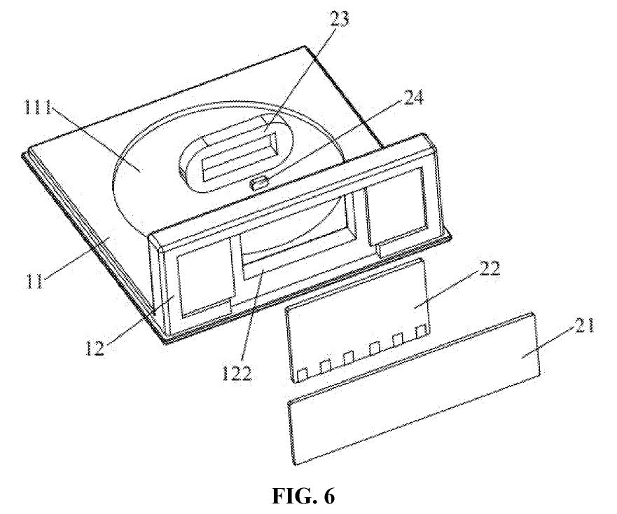

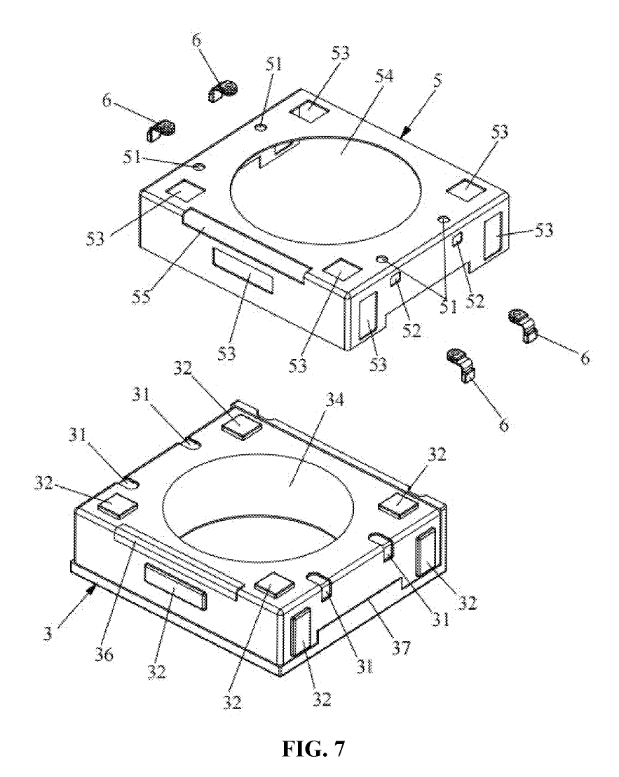

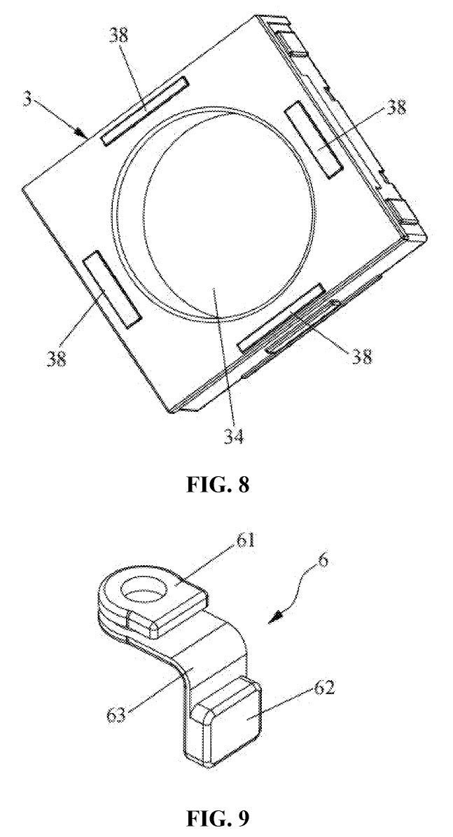

As shown in FIGS. 1-9, the driving device provided in this embodiment includes a base 1, a housing 7, a carrier 3, a driving element 9, a cover 5, and a shock absorption member 6. The housing 7 is connected to the base 1. An accommodating space 72 is formed between the housing 7 and the base 1. The carrier 3 is disposed in the accommodating space 72. The driving element 9 is connected between the carrier 3 and the base 1 and configured to drive the carrier 3 to move in a first direction relative to the base 1. The cover 5 is disposed on the carrier 3. The cover 5 is provided with an open structure configured to avoid the driving element 9. The shock absorption member 6 is connected to the cover 5, and a gap exists between the shock absorption member 6 and the housing 7. The shock absorption member 6 includes a first shock absorption portion 61 and a second shock absorption portion 62. The first shock absorption portion 61 protrudes from the top of the cover 5. The second shock absorption portion 62 protrudes from a side of the cover 5. In this embodiment, the base 1 is used as a fixed portion of the driving device, the carrier 3 is used as an actuation portion of the driving device, and the driving element 9 can drive the carrier 3 to move along the first direction relative to the base 1. Exemplarily, when the driving device is applied to the camera assembly, the first direction is the optical axis direction of the lens assembly. In this case, the carrier 3 can drive the lens assembly to reciprocate along the optical axis direction thereof, to implement a focusing function and a zooming function.

The first shock absorption portion 61 in this embodiment protrudes from the top of the cover 5 and can cushion the impact force between the top of the carrier 3 and the housing 7 during movement. The second shock absorption portion 62 protrudes from the side of the cover 5 and can cushion the impact force between the side of the carrier 3 and the housing 7 during the movement. The entire shock absorption member 6 can absorb the noise generated by the impact of the carrier 3 during the movement, absorb the shock, and improve the shock absorption and noise reduction performance of the driving device. In this embodiment, the shock absorption member 6 is made of an elastic material such as silica gel, rubber, or resin to better absorb the impact force generated by the shock and protect the driving device from being influenced by the shock. In one or more embodiments, multiple shock absorption members 6 are provided and are symmetrically distributed on two opposite sides of the carrier 3. In addition, the shock absorption member 6 may be disposed on the front side of the carrier 3.

In this embodiment, the shock absorption member 6 further includes a connecting portion 63, and the first shock absorption portion 61 and the second shock absorption portion 62 are connected to each other through the connecting portion 63. The connecting portion 63 is L-shaped and is attached to and fixed to the top of the carrier 3 and the side of the carrier 3 separately. In some embodiments, the first shock absorption portion 61, the second shock absorption portion 62, and the connecting portion 63 are an integrated structure. Furthermore, a first fixing hole 51 is provided at the top of the cover 5, and the first shock absorption portion 61 is fixed to the first fixing hole 51; a second fixing hole 52 is provided at the side of the cover 5, and the second shock absorption portion 62 is fixed to the second fixing hole 52; and a fixing slot 31 is provided at the intersection between the top of the carrier 3 and the side of the carrier 3, and the connecting portion 63 is fixed in the fixing slot 31. The preceding fixing manner may be engagement, bonding, integrated injection molding, or the like, as long as the shock absorption member 6 can be reliably fixed.

In some embodiments, the radial dimension of the part of the first shock absorption portion 61 that is higher than the top surface of the cover 5 is greater than or equal to the dimension of the first fixing hole 51; and the radial dimension of the part of the second shock absorption portion 62 that is higher than the side surface of the cover 5 is greater than or equal to the dimension of the second fixing hole 52. This configuration makes the connection between the shock absorption member 6 and the cover 5 more stable and reliable, which can effectively prevent the shock absorption member 6 and the cover 5 from loosening.

Furthermore, several first limit blocks 32 protruding from the top of the carrier 3 and the side of the carrier 3 are provided, the cover 5 is provided with several limit holes 53 whose positions correspond to positions of the first limit blocks 32, and each first limit block 32 passes through a respective limit hole 53 and protrudes from the cover 5. In this embodiment, the first limit blocks 32 are provided and can limit and cushion the movement of the carrier 3 to prevent the carrier 3 from damaging the housing 7 due to an excessively long movement stroke. The first limit blocks 32 are fixed through the limit holes 53, thereby increasing the reliability of the connection between the carrier 3 and the cover 5. Furthermore, the height of the first shock absorption portion 61 protruding from the cover 5 and the height of the second shock absorption portion 62 protruding from the cover 5 are greater than the height of the first limit blocks 32 protruding from the cover 5. Thus, when the carrier 3 moves in the housing 7, the first shock absorption portion 61 and the second shock absorption portion 62 can first serve as cushions and absorb shocks for the housing 7, thereby effectively reducing noise generated by the movement and impact of the carrier 3. In this embodiment, the radial dimension of the first limit blocks 32 that is higher than the cover 5 is greater than or equal to the dimension of the limit holes 53, thereby further increasing the firmness of the connection between the carrier 3 and the cover 5 and preventing the cover 5 and the carrier 3 from loosening. In addition, several second limit blocks 38 may be disposed at the bottom of the carrier 3 to reduce the impact between the carrier 3 and the base 1. In addition, a strip-shaped protrusion 36 is further disposed at the intersection between the top of the carrier 3 and the front side of the carrier 3. A strip-shaped hole 55 is provided at a corresponding position on the cover 5. The strip-shaped protrusion 36 passes through the strip-shaped hole 55 and is fixedly connected to the strip-shaped hole 55, thereby further increasing the stability of the connection between the cover 5 and the carrier 3.

In this embodiment, the carrier 3 is made of plastic, and the shock absorption member 6 can be fixed to the cover 5 and the carrier 3 through two forming processes. The first forming process is as follows: the shock absorption member 6 is integrally formed with the cover 5 into a combination through injection molding by using the cover 5 as an insert. The second forming process is as follows: the carrier 3 is integrally formed with the combination of the shock absorption member 6 and the cover 5 through the injection molding. With the preceding configuration, the shock absorption member 6, the cover 5, and the carrier 3 are processed into an integrated structure. Thus, the shock absorption member 6 is fixed more firmly and the structure is more stable, avoiding the shake among the shock absorption member 6, the cover 5, and the carrier 3, which is beneficial to further reducing the noise of the driving device.

In one or more embodiments, the base 1 includes a bottom plate 11, a support wall 12 is disposed on the bottom plate 11 and is located on a side of the bottom plate 11, and the driving element 9 is connected between the support wall 12 and the carrier 3. In this embodiment, the bottom plate 11 and the support wall 12 may be an integrated structure or a split structure. When the split structure is used, the support wall 12 may be fixed to the bottom plate 11 through bonding, threaded connection, engagement, or the like. Furthermore, the support wall 12 in this embodiment is arranged to be perpendicular to the bottom plate 11.

In this embodiment, the carrier 3 is slidably connected to the support wall 12. In some embodiments, a first sliding groove 33 is provided on the side of the carrier 3 opposite to the support wall 12, and a second sliding groove 121 is provided on the side of the support wall 12 opposite to the carrier 3. The first sliding groove 33 and the second sliding groove 121 both extend along the first direction. A guide member 8 is mounted between the first sliding groove 33 and the second sliding groove 121 so that the carrier 3 is slidable relative to the base 1 along the first direction. The preceding configuration increases the smoothness and operation accuracy with which the carrier 3 moves along the first direction. In some embodiments, the guide member 8 may be several balls or may be a guide column extending along the first direction, both of which can perform a good guide function. The balls are used as the guide member in this embodiment.

Furthermore, a first mounting slot 35 is provided on the side of the carrier 3 facing the support wall 12, and a second mounting slot 122 is provided on the support wall 12. The driving device in this embodiment may perform driving through a voice coil motor or a piezoelectric material, or in other manners. In some embodiments, the voice coil motor is used for driving. In one or more embodiments, the driving element 9 includes a coil assembly 2 and a magnet assembly 4, the magnet assembly 4 is mounted in the first mounting slot 35, the coil assembly 2 is mounted in the second mounting slot 122, and the coil assembly 2 is disposed opposite to the magnet assembly 4.

In one or more embodiments, the coil assembly 2 includes a shielding plate 21, a circuit board 22, a coil 23, and a sensor 24. The shielding plate 21, the circuit board 22, and the coil 23 are mounted sequentially in the second mounting slot 122 of the support wall 12 from the side facing away from the magnet assembly 4 to the side facing the magnet assembly 4. The sensor 24 is connected to the circuit board 22 and configured to sense a change in the magnetic field. The circuit board 22 in this embodiment may be a flexible circuit board, a rigid circuit board, or a rigid-flex circuit board. When the circuit board is a flexible circuit board, a reinforcement plate may also be provided to increase the strength of the flexible circuit board. In some embodiments, the magnet assembly 4 includes several magnets combined together, and each magnet is mounted in the first mounting slot 35.

In this embodiment, the cover 5 covers the carrier 3, and the bottom of the cover 5 is configured to be open to facilitate processing and assembly. In addition, the side of the cover 5 facing the support wall 12 is also configured to be open to avoid shielding the magnet assembly 4. The cover 5 is made of metal, which can serve to dissipate heat from the driving device. In one or more embodiments, the cover 5 may be made of iron, stainless steel, or the like. Furthermore, limit steps 37 adapted to the contour edge of the open end of the cover 5 are also disposed on the side surface of the carrier 3 and the top surface of the carrier 3. Thus, the cover 5 can be well limited, and the carrier 3 and the cover 5 are better connected and fixed.

In this embodiment, the housing 7 is fastened on the base 1, and the coil assembly 2, the carrier 3, the magnet assembly 4, the cover 5, and the shock absorption member 6 are all accommodated in the accommodating space 72 between the housing 7 and the base 1. Thus, the housing 7 can protect internal components well. In one or more embodiments, the housing 7 is made of metal. The housing 7 is a quadrilateral housing with an open lower end. In one or more embodiments, a metal material may be die-cut and bent and then four closed sides are laser welded such that the housing 7 is formed.

To facilitate the application of the driving device in a camera apparatus, a first through hole 34 is further formed on the carrier 3, a lens assembly is mounted in the first through hole 34, a second through hole 54 is formed on the cover 5, a third through hole 71 is formed on the housing 7, a fourth through hole 111 is formed on the bottom plate 11, and the second through hole 54, the third through hole 71, and the fourth through hole 111 are coaxially arranged with the first through hole 34 for the lens assembly to pass through. With this configuration, when the focal length of the lens assembly needs to be adjusted, the driving element 9 can drive the carrier 3 so that the carrier 3 drives the lens assembly to reciprocate relative to the base 1 along the optical axis direction, thereby implementing zooming.

This embodiment further provides a camera assembly. The camera assembly includes a lens assembly and the preceding driving device. The lens assembly is mounted in the carrier 3 of the driving device. The driving device is configured to drive the lens assembly to move along the first direction, and the first direction is the optical axis direction of the lens assembly. Since the camera assembly adopts all the technical solutions in all the preceding embodiments of the driving device, the camera assembly has at least all the beneficial effects brought by the technical solutions in the preceding embodiments. The details are not repeated here.

Apparently, the preceding embodiments of the present disclosure are illustrative examples of the present disclosure and are not intended to limit embodiments of the present disclosure. Those of ordinary skill in the art can make various apparent modifications, adaptations, and substitutions without departing from the scope of the present disclosure. All embodiments do not need to be and cannot be exhausted herein. Any modifications, equivalent substitutions, and improvements made within the spirit and principle of the present disclosure fall within the scope of the claims of the present disclosure.

What is claimed is:

1. A driving device, comprising:
a base;
a housing connected to the base, wherein an accommodating space is formed between the housing and the base;
a carrier disposed in the accommodating space;
a driving element, wherein the driving element is connected between the carrier and the base and configured to drive the carrier to move in a first direction relative to the base;
a cover disposed on the carrier, wherein the cover is provided with an open structure configured to avoid the driving element; and
a shock absorption member connected to the cover, wherein the shock absorption member comprises a first shock absorption portion and a second shock absorption portion, the first shock absorption portion protrudes from a top of the cover, and the second shock absorption portion protrudes from a side of the cover.

2. The driving device according to claim 1, wherein the shock absorption member further comprises a connecting portion, the first shock absorption portion and the second shock absorption portion are connected to each other through the connecting portion, the connecting portion is L-shaped, and the connecting portion is attached and fixed to the top of the carrier and the side of the carrier separately.

3. The driving device according to claim 2, wherein a first fixing hole is provided at the top of the cover, and the first shock absorption portion is fixed to the first fixing hole; a second fixing hole is provided at the side of the cover, and the second shock absorption portion is fixed to the second fixing hole; and a fixing slot is provided at an intersection between the top of the carrier and the side of the carrier, and the connecting portion is fixed in the fixing slot.

4. The driving device according to claim 3, wherein a radial dimension of a part of the first shock absorption portion that is higher than a top surface of the cover is greater than or equal to a dimension of the first fixing hole.

5. The driving device according to claim 3, wherein a radial dimension of a part of the second shock absorption portion that protrudes from a side surface of the cover is greater than or equal to a dimension of the second fixing hole.

6. The driving device according to claim 3, wherein a radial dimension of a part of the first shock absorption portion that is higher than a top surface of the cover is greater than or equal to a dimension of the first fixing hole, and
a radial dimension of a part of the second shock absorption portion that protrudes from a side surface of the cover is greater than or equal to a dimension of the second fixing hole.

7. The driving device according to claim 1, wherein a plurality of first limit blocks protrude from the top of the carrier and the side of the carrier, the cover is provided with a plurality of limit holes whose positions correspond to positions of the plurality of first limit blocks, and each of the plurality of first limit blocks passes through a respective one of the plurality of limit holes and protrudes from the cover.

8. The driving device according to claim 1, wherein a second limit block is disposed on a bottom of the carrier.

9. The driving device according to claim 1, wherein a plurality of first limit blocks protrude from the top of the carrier and the side of the carrier, the cover is provided with a plurality of limit holes whose positions correspond to positions of the plurality of first limit blocks, and each of the plurality of first limit blocks passes through a respective one of the plurality of limit holes and protrudes from the cover; and
a second limit block is disposed on a bottom of the carrier.

10. The driving device according to claim 7, wherein a height of the first shock absorption portion protruding from the cover and a height of the second shock absorption portion protruding from the cover are greater than a height of the plurality of first limit blocks protruding from the cover.

11. The driving device according to claim 1, wherein a material of the cover is metal, a material of the shock absorption member is silica gel, rubber, or resin, and a material of the carrier is plastic.

12. The driving device according to claim 1, wherein a plurality of shock absorption members are provided and distributed on the carrier at intervals.

13. The driving device according to claim 1, wherein a material of the cover is metal, a material of the shock absorption member is silica gel, rubber, or resin, a material of the carrier is plastic; and
a plurality of shock absorption members are provided and distributed on the carrier at intervals.

14. The driving device according to claim 11, wherein the shock absorption member is integrally formed with the cover into a combination through injection molding by using the cover as an insert, and the carrier is integrally formed with the combination through injection molding.

15. The driving device according to claim 1, wherein the base comprises a bottom plate, a support wall is disposed on the bottom plate and is located on a side of the bottom plate, and the driving element is connected between the support wall and the carrier.

16. The driving device according to claim 15, wherein a first sliding groove is provided on a side of the carrier opposite to the support wall, a second sliding groove is provided on a side of the support wall opposite to the carrier, and a guide member is mounted between the first sliding groove and the second sliding groove so that the carrier is slidably connected to the base.

17. The driving device according to claim 15, wherein a first mounting slot is provided on a side of the carrier opposite to the support wall, a second mounting slot is provided on a side of the support wall opposite to the carrier, the driving element comprises a coil assembly and a magnet assembly, the magnet assembly is mounted in the first mounting slot, and the coil assembly is mounted in the second mounting slot; and the coil assembly comprises a shielding plate, a circuit board, a coil, and a sensor, the shielding plate, the circuit board, and the coil are mounted on the support wall sequentially from a side of the support wall facing away from the magnet assembly to a side of the support wall facing the magnet assembly, and the sensor is connected to the circuit board.

18. The driving device according to claim 15, wherein a first sliding groove is provided on a side of the carrier opposite to the support wall, a second sliding groove is provided on a side of the support wall opposite to the carrier, and a guide member is mounted between the first sliding groove and the second sliding groove so that the carrier is slidably connected to the base; and
a first mounting slot is provided on the side of the carrier opposite to the support wall, a second mounting slot is provided on the side of the support wall opposite to the carrier, the driving element comprises a coil assembly and a magnet assembly, the magnet assembly is mounted in the first mounting slot, and the coil assembly is mounted in the second mounting slot; and the coil assembly comprises a shielding plate, a circuit board, a coil, and a sensor, the shielding plate, the circuit board, and the coil are mounted on the support wall sequentially from a side of the support wall facing away from the magnet assembly to a side of the support wall facing the magnet assembly, and the sensor is connected to the circuit board.

19. The driving device according to claim 15, wherein a first through hole is provided in the carrier, a lens assembly is mounted in the first through hole, a second through hole is provided in the cover, a third through hole is provided in the housing, a fourth through hole is provided in the bottom plate, and the second through hole, the third through hole, and the fourth through hole are configured to be coaxially arranged with the first through hole to enable the lens assembly to pass through.

20. A camera assembly, comprising a lens assembly and a driving device, wherein the driving device comprises a base, a housing connected to the base, a carrier disposed in an accommodating space formed between the housing and the base, a driving element connected between the carrier and the base, a cover disposed on the carrier, and a shock absorption member connected to the cover, wherein the driving element is configured to drive the carrier to move in a first direction relative to the base, the cover is provided with an open structure configured to avoid the driving element; the shock absorption member comprises a first shock absorption portion and a second shock absorption portion, the first shock absorption portion protrudes from a top of the cover, and the second shock absorption portion protrudes from a side of the cover;
wherein the lens assembly is mounted in the carrier of the driving device, the driving device is configured to drive the lens assembly to move along the first direction, and the first direction is an optical axis direction of the lens assembly.
